(19) United States
(12) Patent Application Publication
(10) Pub. No.: US 2014/0118875 A1
(43) Pub. Date: May 1, 2014

(54) CONTROL AND MONITORING UNIT FOR A CIRCUIT INTERRUPTER ELECTRONIC TRIP UNIT AND SYSTEM INCLUDING SAME

(71) Applicant: EATON CORPORATION, Cleveland, OH (US)

(72) Inventors: Harry J. Carlino, Export, PA (US); David R. Rohn, Venetia, PA (US); Todd M. Shaak, Presto, PA (US); David R. Olenak, Bridgeville, PA (US)

(73) Assignee: Eaton Corporation, Cleveland, OH (US)

(21) Appl. No.: 13/664,833

(22) Filed: Oct. 31, 2012

(51) Int. Cl. H02H 3/08

(52) U.S. Cl. 361/93.2

(57) ABSTRACT

A circuit interrupter system includes a circuit interrupter including a processing unit, a serial port interface operatively coupled to the processing unit for enabling communication with the processing unit, and a USB processing unit configured to run a USB stack and operatively coupled to the serial port interface for enabling communication with the processing unit through the serial port interface, and a portable computing device selectively connectable to the USB processing unit of the circuit interrupter through a USB connection, the portable computing device being structured to function as a USB host and to implement a graphical user interface for enabling communication between the portable computing device and the processing unit of the circuit interrupter through the serial port interface and the USB processing unit when the portable computing device is connected to the USB processing unit of the circuit interrupter.

### BACKGROUND

1. Field

This invention pertains generally to circuit interrupters and, more particularly, to configurable circuit interrupter electronic trip units and a control and monitoring unit for monitoring, displaying and/or changing conditions, parameters, settings and/or events within circuit interrupter electronic trip units.

2. Background Information

Electrical switching apparatus such as circuit interrupters and, in particular, circuit breakers of the molded case variety, are well known in the art. See, for example, U.S. Pat. No. 5,341,191.

Circuit breakers are used to protect electrical circuitry from damage due to an overcurrent condition, such as an overload condition or a relatively high level short circuit or fault condition. Molded case circuit breakers typically include a pair of separable contacts per phase. The separable contacts may be operated either manually by way of a handle disposed on the outside of the case or automatically in response to an overcurrent condition. Typically, such circuit breakers include: (i) an operating mechanism which is designed to rapidly open and close the separable contacts, and (ii) a trip unit which senses overcurrent conditions in an automatic mode of operation. Upon sensing an overcurrent condition, the trip unit trips the operating mechanism to a trip state, which moves the separable contacts to their open position.

Industrial circuit breakers often use a circuit breaker frame which houses a trip unit. See, for example, U.S. Pat. Nos. 5,910,760; and 6,144,271. The trip unit may be modular and may be replaced in order to alter the electrical properties of the circuit breaker.

It is well known to employ trip units which utilize a microprocessor to detect various types of overcurrent trip conditions and to provide various protection functions, such as, for example, a long delay trip, a short delay trip, an instantaneous trip, and/or a ground fault trip. The long delay trip function protects the load served by the protected electrical system from overloads and/or overcurrents. The short delay trip function can be used to coordinate tripping of downstream circuit breakers in a hierarchy of circuit breakers. The instantaneous trip function protects the electrical conductors to which the circuit breaker is connected from damaging overcurrent conditions, such as short circuits. As implied, the ground fault trip function protects the electrical system from faults to ground.

Each circuit breaker is designed for a specific maximum continuous current. This current rating may be set by a suitable selection mechanism, such as by a rotary switch or by selection of a resistor (e.g., a “rating plug”) which converts a current to a voltage for use by the trip unit. In some instances, a single circuit breaker frame may be easily adapted for installations which call for a range of maximum continuous currents, up to the design limits of the frame, through use of the selection mechanism by which the current rating of the device can be established. Typically, the pick-up currents for the various protection functions have been selectable multiples or fractions of this current rating. Thus, instantaneous protection trips the device any time the current reaches a selected multiple of the rated current, such as, for example, ten times the rated current. Pick-up for short delay protection is a lesser multiple of the rated current, while pick-up current for long delay protection may be a fraction of the rated current. Typically, the short delay trip is only generated when the short delay pick-up current is exceeded for a short delay time interval, although, in some applications, an inverse time function is also used for short delay protection.

Currently, many electronic trip units use adjustable (e.g., without limitation, rotary) switches to vary functional trip settings, such as, for example and without limitation, long delay pickup (Ir), long delay time (LDT), short delay pickup (SDPU), ground fault pickup (GFPU), and short delay time and ground fault time (SDT/GFT). The adjustable switches are typically labeled on a per unit basis and are common to all current sensor (e.g., current transformer) types. The Ir adjustable switch is based upon a percentage of the current sensor. For example, the Ir adjustable switch has eight positions. The lowest position represents 40% of the current sensor rating and the highest position corresponds to 100% of the current sensor rating.

Manufacturers of circuit interrupters readily seek to reduce the size and cost of circuit interrupters and electronic trip units. Hence, it is desirable to maintain the full functionality of an electronic trip unit while reducing its cost. It is also desirable to eliminate components of an electronic trip unit while also maintaining all its functions.

There is room for improvement in systems including circuit interrupter trip units.

### SUMMARY

These needs and others are met by embodiments of the disclosed concept.

In one embodiment, a circuit interrupter system is provided that includes a circuit interrupter including a processing unit and configured to run a USB stack for enabling communication with the processing unit, and a portable computing device selectively connectable to the circuit interrupter through a USB connection, the portable computing device being structured to function as a USB host and to implement a graphical user interface for enabling communication between the portable computing device and the processing unit of the circuit interrupter when the portable computing device is connected to the USB processing unit of the circuit interrupter.

In another embodiment, a circuit interrupter is provided that includes a processing unit, wherein the circuit interrupter is configured to function as a USB peripheral responsive to a portable computing device functioning as a USB host being connected to the processing unit through a USB connection to thereby enable communication between the portable computing device and the processing unit of the circuit interrupter.

In another embodiment a portable computing device is provided that is structured to be selectively connectable to a circuit interrupter through a USB connection. The portable computing device includes a display and a processor apparatus storing one or more routines executable by the processor apparatus, the one or more routines being adapted to cause the portable computing device to function as a USB host, and implement a graphical user interface displayable on the display, the graphical user interface enabling communication between the portable computing device and a processing unit of the circuit interrupter when the portable computing device is connected to the circuit interrupter.

In still another embodiment, a computer program product tangibly embodied on a computer readable medium of a portable computing device structured to be selectively connectable a circuit interrupter through a USB connection is provided, wherein the computer program product includes one or more routines executable by a processor apparatus of the portable computing device. The one or more routines are adapted to implement a graphical user interface displayable on a display of the portable computing device, the graphical user interface enabling communication between the portable computing device and a processing unit of the circuit interrupter when the portable computing device is connected to the circuit interrupter.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of a circuit interrupter system according to an exemplary embodiment of the present invention;

FIG. 2 is a schematic diagram showing certain selected components of an electronic trip unit of the system of FIG. 1 according to the exemplary embodiment;

FIG. 3 is a schematic diagram showing certain selected components of a portable computing device of the system of FIG. 1 according to the exemplary embodiment;

FIGS. 4A-4H show various screens of a GUI implemented on the portable computing device of FIG. 3 according to the exemplary embodiment;

FIG. 5 is a schematic diagram showing certain selected components of a portable computing device according to an alternative exemplary embodiment;

FIG. 6 is a schematic diagram of a circuit interrupter system according to an alternative exemplary embodiment of the present invention;

FIG. 7 is a schematic diagram showing certain selected components of an electronic trip unit of the system of FIG. 6 according to the alternative exemplary embodiment; and

FIG. 8 is a schematic diagram showing certain selected components of a USB module of the system of FIG. 6 according to the alternative exemplary embodiment.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

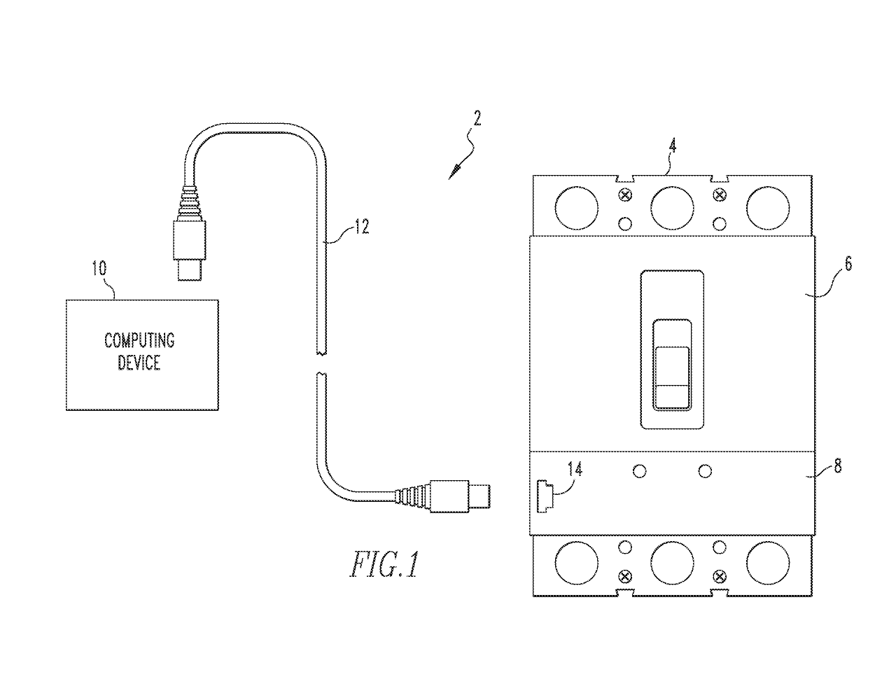

FIG. 1 is a schematic diagram of a circuit interrupter system 2 according to an exemplary embodiment of the present invention. Circuit interrupter system 2 includes a configurable circuit interrupter 4 (in the illustrated embodiment, configurable circuit interrupter 4 is a molded case circuit breaker) having an operating mechanism 6 configured to rapidly open and close the separable contacts of circuit interrupter 4 and an electronic trip unit 8 operatively coupled to operating mechanism 6 which, in an automatic mode of operation, is structured to sense overcurrent conditions and in response thereto move operating mechanism 6 to a state wherein the separable contacts of circuit interrupter 4 are open. As seen in FIG. 1, in the illustrated embodiment, electronic trip unit 8 does not include a number of adjustable switches for varying the functional trip settings (such as, for example and without limitation, long delay pickup (Ir), long delay time (LDT), short delay pickup (SDPU), ground fault pickup (GFPU), and short delay time and ground fault time (SDT/GFT)) of electronic trip unit 8. Instead, as described in detail herein, circuit interrupter system 2 includes a settings emulator in the form of a portable computing device 10 that, in the illustrated embodiment, is structured to communicate with the microprocessor of electronic trip unit 8 though a plug and play USB interface comprising USB cable 12 that is selectively connectable to a mini USB connector 14 provided as part of electronic trip unit 8. In this configuration, computing device 10 acts as a USB host and electronic trip unit 8 is recognized as a USB peripheral device (in particular, a human interface device (HID). Thus, among other functionality described in detail herein, an operator is able to (i) establish functional trip settings for electronic trip unit 8 by inputting the desired setting into a graphical user interface (GUI) provided on computing device 10 and transmitting the settings to electronic trip unit 8 over the USB interface, and (ii) read the current functional trip settings for electronic trip unit 8 using the GUI of computing device 10 and the USB interface.

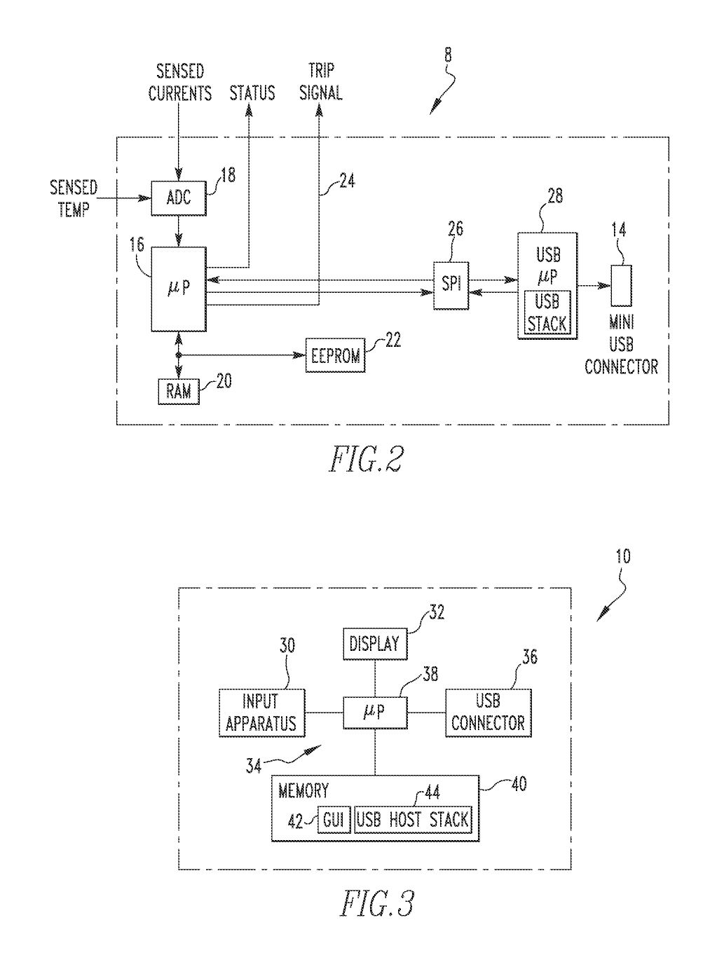

FIG. 2 is a schematic diagram showing certain selected components of electronic trip unit 8 according to the exemplary embodiment. As seen in FIG. 2, electronic trip unit 8 includes a microprocessor (μP) 16 which controls the operation of electronic trip unit 8. Alternatively, microprocessor 16 may be another type of processing or control unit, such as, without limitation, a microcontroller or some other suitable processing device. Electronic trip unit 8 further includes an analog-to-digital converter (ADC) 18, a random access memory (RAM) 20 and an EEPROM 22, each of which is coupled to microprocessor 16. ADC 18 is structured to receive signals, such as a temperature signal (indicating a temperature within circuit interrupter 4) and a number of current signals (indicating the current of each phase of the system to which circuit interrupter 4 is connected), that are sensed by sensors (not shown; e.g., a thermistor and/or a number of current transformers) forming part of circuit interrupter 4 and convert those signals to digital data that is appropriate for microprocessor 16. As will be appreciated, that data may be stored in RAM 20 and/or used by the trip unit program implemented in microprocessor 16 in determining whether and when to issue a trip signal 24 for tripping operating mechanism 6. In addition, in the exemplary embodiment, EEPROM 22 stores the functional trip settings (such as, for example and without limitation, long delay pickup (Ir), long delay time (LDT), short delay pickup (SDPU), ground fault pickup (GFPU), and short delay time and ground fault time (SDT/GFT)) of electronic trip unit 8, which are read into microprocessor 16 as needed by the trip unit program.

Electronic trip unit 8 also includes an internal serial port interface (SPI) 26 provided as part of the printed circuit board (PCB) electronics of electronic trip unit 8. SPI 26 is operatively coupled to microprocessor 16 to allow for serial communication with microprocessor 16. The PCB electronics of electronic trip unit 8 further includes USB microprocessor 28, which is an integrated circuit chip that is configured to run a USB stack. USB microprocessor 28 running the USB stack allows electronic trip unit 8 to connect with a USB host (e.g., computing device 10 described elsewhere herein) and plug and play communicate with the USB host. The USB stack is usually supplied by the chip vendor at no additional cost. USB microprocessor 28 also has an on-board serial port interface (SPI) (as well as a Universal Asynchronous Receiver/Transmitter (UART) for translating data between parallel and serial forms). The on-board SPI enables communication with SPI 26 and thus provides for communication between USB microprocessor 28 and microprocessor 16. In addition, that same configuration thus allows for a device coupled to USB connector 14 (e.g., computing device 10) to communicate with microprocessor 16 through SPI 26 and USB microprocessor 28.

An exemplary portable computing device 10 that may be used in system 2 is depicted schematically in FIG. 3. The exemplary portable computing device 10 may be, for example and without limitation, a laptop or notebook PC, a tablet PC, a smartphone, or a personal data assistant (PDA). As seen in FIG. 3, portable computing device 10 includes an input apparatus 30 (e.g., a keyboard, a keypad, or a touch screen), a display 32, a processor apparatus 34, and a USB connector 36. A user is able to provide input into processor apparatus 34 using input apparatus 30, and processor apparatus 34 provides output signals to display 32 to enable display 32 to display information to the user as described in detail herein.

Processor apparatus 34 comprises a microprocessor (μP) 38 (or other suitable processing device) and a memory 40 that interfaces with microprocessor 38. Memory 40 can be any one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. Memory 40 has a number of routines stored therein that are executable by microprocessor 38. One or more of the routines implement (by way of computer/processor executable instructions) a graphical user interface (GUI) software application 42 that is described in greater detail below and that is configured to, among other things, enable a user to monitor, display and/or change conditions, parameters, settings and/or events within circuit interrupter 4 (graphical user interface (GUI) software application 42 thus comprises a computer program product tangibly embodied on a computer readable medium of the portable computing device 10). Another one or more of the routines comprise a USB host stack 44 that enables computing device 10 to function as a USB host and, on a plug-and-play basis, communicate with USB peripheral devices (e.g., HIDs) through USB connector 36. Thus, according to an aspect of the present invention, computing device 10 is able to function as a USB host and be connected to trip unit 8 using USB cable 12 (FIG. 1). In such a configuration, trip unit 8 will be recognized by computing device 10 as a USB peripheral, and a user may then use GUI 42 to monitor, display and/or change conditions, parameters, settings and/or events within circuit interrupter 4 by communicating with microprocessor 16 as described elsewhere herein.

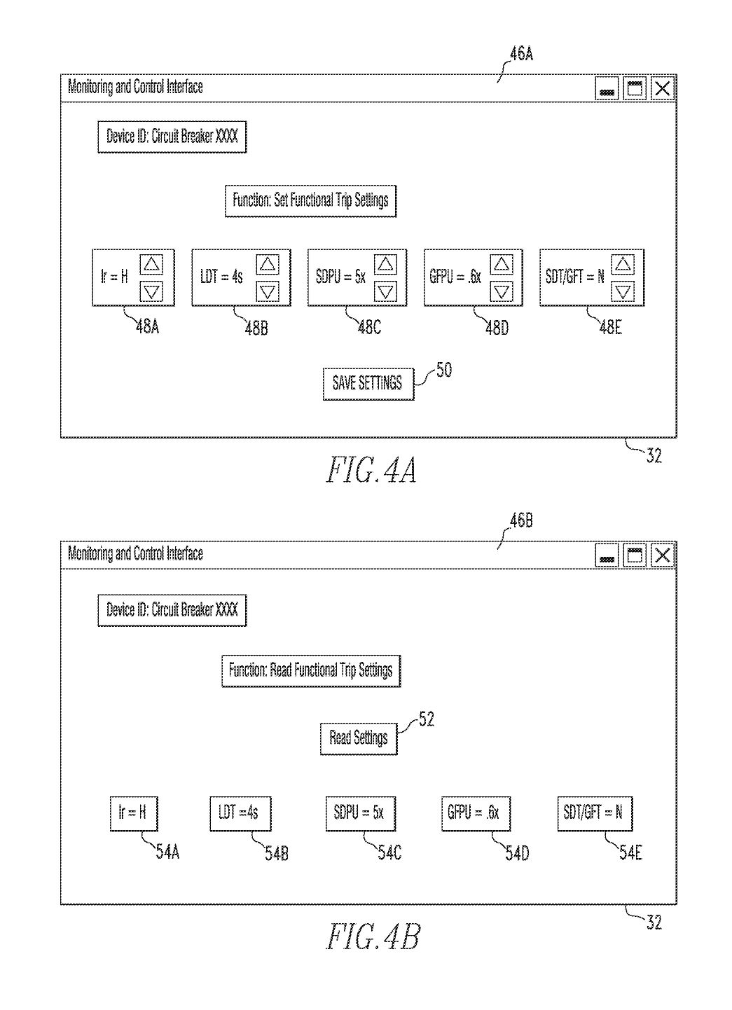

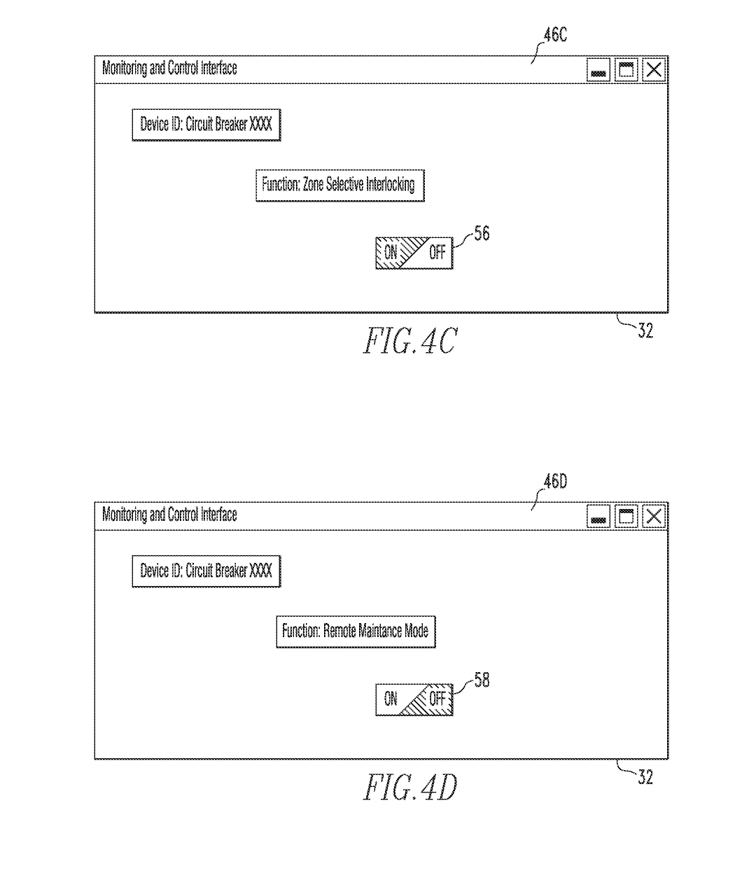

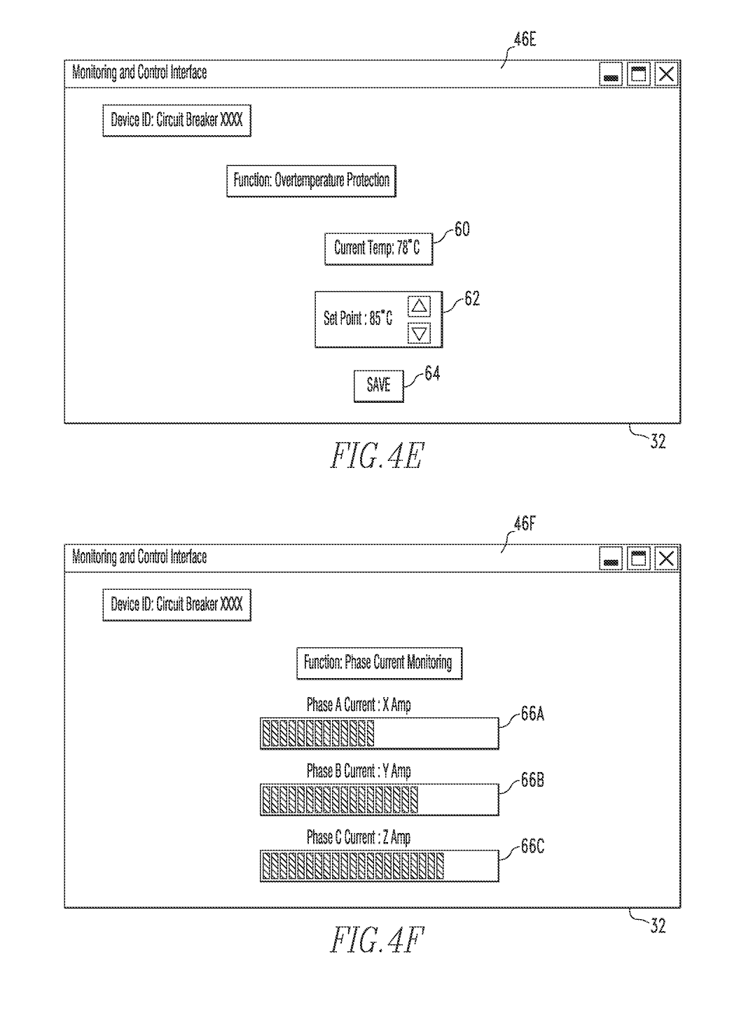

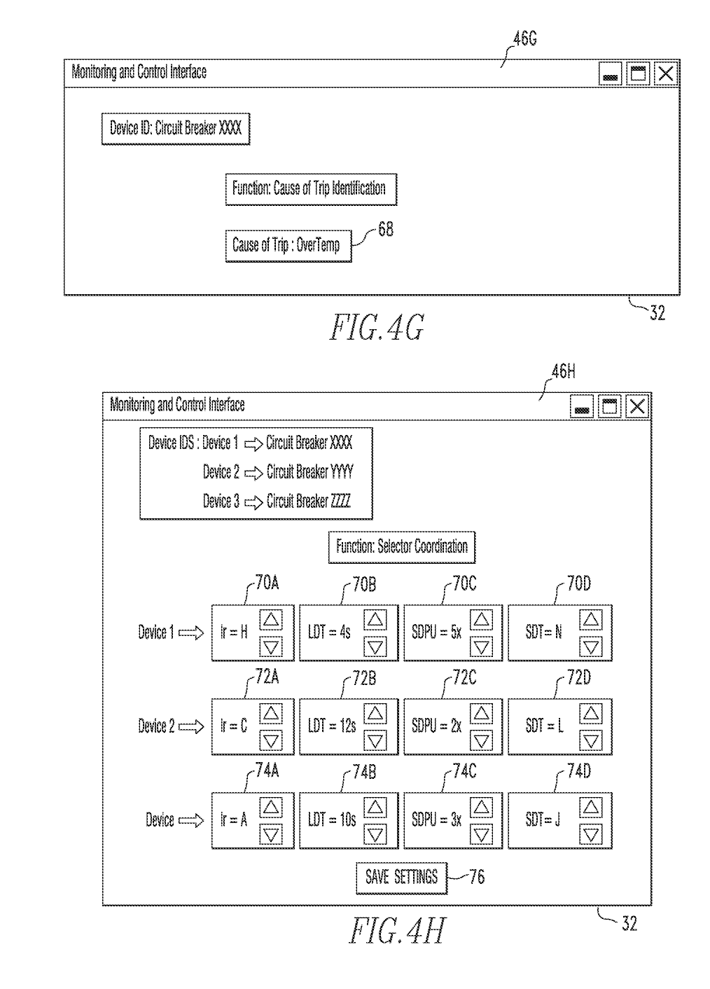

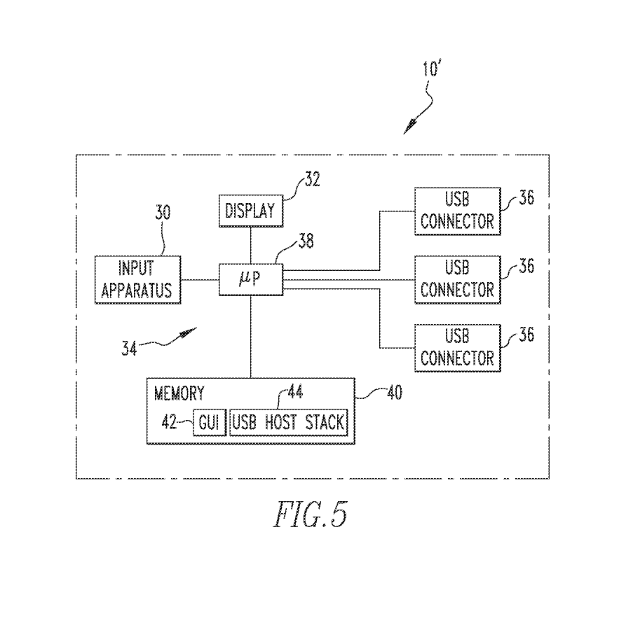

FIGS. 4A-4H show various screens of GUI 42 according to an exemplary, non-limiting embodiment of the present invention which demonstrate certain functionality provided by GUI 42 for monitoring, displaying and/or changing conditions, parameters, settings and/or events within circuit interrupter 4 when computing device 10 is coupled to circuit interrupter 4 using USB cable 12 and the USB interconnection described herein.

Referring to FIG. 4A, in one aspect of the present invention, GUI 42 enables a user to adjust the functional trip settings of trip unit 8 when computing device 10 is coupled to electronic trip unit 8 using the USB connection. Thus, as seen in FIG. 4A, a screen 46A generated by GUI 42 on display 32 includes toggle buttons 48A-48E for changing each of the functional trip settings of electronic trip unit 8. When a user has set each of the values using buttons 48A-48E, “Save Settings” button 50 may be “pressed” (i.e., selected) to save the settings. In response, the values that were set will be communicated to microprocessor 16 of electronic trip unit 8 through the USB interconnection between the two devices. Those settings may then be stored, for example in EEPROM 22, by electronic trip unit 8 for use by the trip unit program implemented in microprocessor 16. Referring to FIG. 4B, in another aspect of the present invention, GUI 42 enables a user easily to determine the current functional trip settings of trip unit 8 when computing device 10 is coupled to electronic trip unit 8 using the USB connection. Thus, as seen in FIG. 4B, a screen 46B generated by GUI 42 on display 32 includes a “Read Settings” button 52. In response to the button 52 being selected, each of the functional trip settings currently stored in electronic trip unit 8 will be read from trip unit 8 (e.g., from EEPROM 22) and communicated from microprocessor 16 of electronic trip unit 8 to microprocessor 38 of computing device 10 through the USB interconnection between the two devices. The current functional trip settings are then displayed to the user in screen 48B in boxes 54A-54E.

As is known in the art, Zone Selective Interlocking (ZSI) is an optional method that provides a wired method of coordinating upstream and downstream breakers. Typically, the coordinating signals are provided by the White\Red stripe (Zin), White\Black stripe (Zout), and Black (common ground) wires that exit the right side of the typical breaker. A typical connection (two breaker system) is accomplished by connecting the Zout wire of the downstream breaker to the Zin of the upstream breaker. The common black wires of both breakers must also be connected. If a high current fault is sensed from the load on the downstream breaker, both breakers will sense the fault. However, the downstream breaker will send the interlock signal to the upstream breaker, informing it not to trip as defined by the SD time settings of both breakers. This delay allows the downstream breaker to clear the fault without the upstream breaker tripping. However, if for some reason the downstream breaker does not clear the fault in the set delay time, the upstream breaker will then clear the fault. The ZSI option is enabled in firmware in the trip of a typical breaker.

According to a further aspect of the present invention, GUI 42 enables a user to easily enable and disable the ZSI option of electronic trip unit 8 when computing device 10 is coupled to electronic trip unit 8 using the USB connection. Thus, as seen in FIG. 4C, a screen 46C generated by GUI 42 on display 32 includes an “ON/OFF” button 56. In response to the button 56 being selected, electronic trip unit 8 can be toggled between a mode wherein ZSI is enabled and a mode wherein ZSI is disabled as a result of appropriate signals being generated by microprocessor 38 of computing device 10 and communicated to microprocessor 16 of electronic trip unit 8 through the USB interconnection between the two devices.

As is known in the art, Remote Maintenance Mode is a safety option that allows a breaker to be remotely placed in the lowest pickup setting and the fastest time setting. This greatly reduces the destructive energy of the breaker under fault conditions and protects people that are standing directly in front of the breaker performing breaker maintenance. Typically, the Remote Maintenance Mode is enabled through an analog relay by applying 24VDC to the two wire cable that exits the left side of the breaker.

According to a further aspect of the present invention, GUI 42 enables a user to easily enable and disable the Remote Maintenance Mode of electronic trip unit 8 when computing device 10 is coupled to electronic trip unit 8 using the USB connection. Thus, as seen in FIG. 4D, a screen 46D generated by GUI 42 on display 32 includes an “ON/OFF” button 58. In response to the button 58 being selected, electronic trip unit 8 can be toggled between a mode wherein Remote Maintenance Mode is enabled and a mode wherein Remote Maintenance Mode is disabled. In particular, selection of the button 58 will cause appropriate signals the be generated by microprocessor 38 of computing device 10 and communicated to microprocessor 16 of electronic trip unit 8 through the USB interconnection between the two device that control operation of the Remote Maintenance Mode of electronic trip unit 8 analog relay of electronic trip unit 8.

In addition, many breakers have an over temperature protection set point that protects the breaker from operating in ambient temperatures above the set point. (standard protection is typically set at 85 degrees C.). If the set point is exceeded, the breaker will trip.

According to a further aspect of the present invention, GUI 42 gives a user the ability to read the ambient temperature (as sensed by a temperature e sensor coupled microprocessor 16) within circuit interrupter 4 and change the over temperature set point (e.g., over the allowable range of 85 degree C. to 105 degree C.) when computing device 10 is coupled to electronic trip unit 8 using the USB connection. Thus, as seen in FIG. 4E, a screen 46E generated by GUI 42 on display 32 includes a box 60 that displays the current ambient temperature read from electronic trip unit 8 (communicated from microprocessor 16 of electronic trip unit 8 to microprocessor 38 of computing device 10 through the USB interconnection between the two devices). Screen 46E also includes a toggle button 62 for changing the over temperature set point of electronic trip unit 8. When a user has set the desired over temperature set point using toggle button 62, a “Save Settings” button 64 may be selected to save that over temperature set point. In response, that value will be communicated to microprocessor 16 of electronic trip unit 8 through the USB interconnection between the two devices. That over temperature set point will then be stored, for example in RAM 20 or EEPROM 22, by electronic trip unit 8 for use by the trip unit program implemented in microprocessor 16.

As described elsewhere herein, ADC 18 of electronic trip unit 8 is structured to receive a number of current signals indicating the current of each phase of the system to which circuit interrupter 4 is connected, and convert those signals to digital data that is appropriate for microprocessor 16. According to a further aspect of the present invention, GUI 42 gives a user the ability to read and compare the current of each phase of the system to which circuit interrupter 4 is connected when computing device 10 is coupled to electronic trip unit 8 using the USB connection. Thus, as seen in FIG. 4F, a screen 46F generated by GUI 42 on display 32 includes a boxes 66A, 66B, 66C that each display (e.g., in numerical and graphical form) the current of each phase of the system to which circuit interrupter 4 is connected (the relevant data is communicated from microprocessor 16 of electronic trip unit 8 to microprocessor 38 of computing device 10 through the USB interconnection between the two devices).

In certain breakers, if the breaker trips, a cause of trip is stored (e.g., in the RAM 20 of electronic trip circuit 8). According to a further aspect of the present invention, GUI 42 gives a user the ability to read and display the cause of trip of circuit interrupter 4 when computing device 10 is coupled to electronic trip unit 8 using the USB connection. Thus, as seen in FIG. 4G, a screen 46G generated by GUI 42 on display 32 includes a box 68 that displays the cause of trip when circuit interrupter 4 is tripped (the relevant data is communicated from microprocessor 16 of electronic trip unit 8 to microprocessor 38 of computing device 10 through the USB interconnection between the two devices).

Selective coordination allows a system of breakers to be prioritized by varying the current pickup and trip times (such as, for example and without limitation, long delay pickup (Ir), long delay time (LDT), short delay pickup (SDPU), and short delay time (SDT)). Usually, the downstream breakers are programmed to trip in the shortest time, and the upstream breakers will trip only if the downstream breakers fail to trip on a fault. In one aspect, selective coordination may be performed on a number of circuit interrupters 4 by sequentially connecting computing device 10 to each electronic trip unit 8 using the USB connection and adjusting the setting as shown in FIG. 4A and described above. Alternatively, computing device 10 may be provided with multiple

USB connectors 36 (FIG. 5, alternative computing device 10′), thereby enabling computing device 10 to be simultaneously connected to multiple electronic trip units 8 using a USB connection (each one will be recognized as a USB peripheral device). Thus, as seen in FIG. 4H, a screen 46H generated by GUI 42 on display 32 includes toggle buttons 70A-70D, 72A-72D and 74A-74D and a “Save Settings” button 76 for changing each of the functional trip settings of each electronic trip unit 8 connected to computing device 10 as described elsewhere herein (FIG. 4A). As a result, selective coordination among the connected electronic trip units 8 may be readily and easily performed.

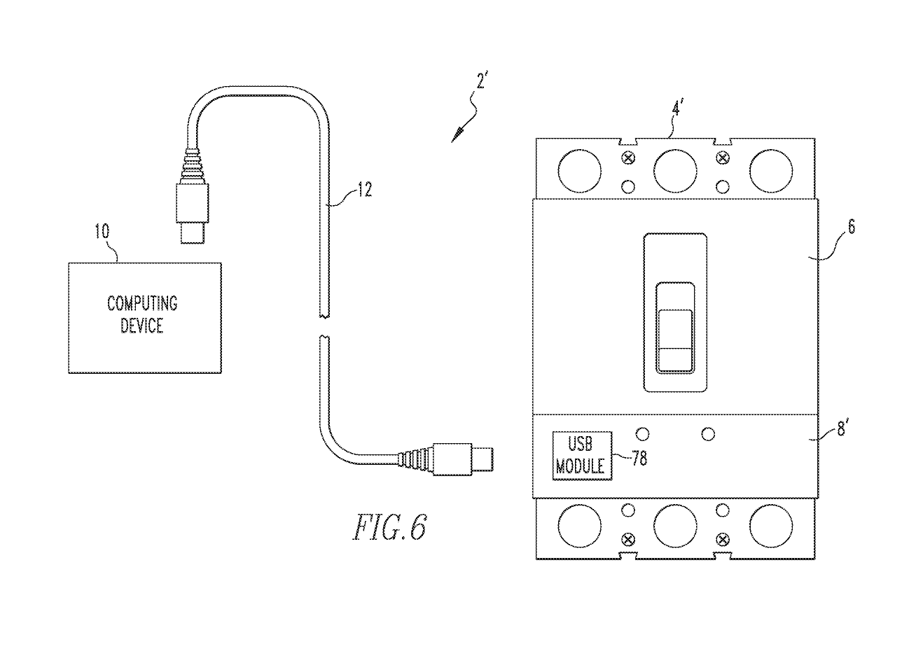

FIG. 6 is a schematic diagram of a circuit interrupter system 2′ according to an alternative exemplary embodiment of the present invention. Circuit interrupter system 2′ is similar to circuit interrupter system 2, and like parts are labeled with like reference numerals. Circuit interrupter system 2′ includes a configurable circuit interrupter 4′ (in the illustrated embodiment, configurable circuit interrupter 4′ is a molded case circuit breaker) having an operating mechanism 6 configured to rapidly open and close the separable contacts of circuit interrupter 4′ and an alternative electronic trip unit 8′ operatively coupled to operating mechanism 6 which, in an automatic mode of operation, is structured to sense overcurrent conditions and in response thereto move operating mechanism 6 to a state wherein the separable contacts of circuit interrupter 4′ are open. As seen in FIG. 1, in the illustrated embodiment, electronic trip unit 8′, like electronic trip unit 8 described elsewhere herein, does not include a number of adjustable switches for varying the functional trip settings (such as, for example and without limitation, long delay pickup (Ir), long delay time (LDT), short delay pickup (SDPU), ground fault pickup (GFPU), and short delay time and ground fault time (SDT/GFT)) of electronic trip unit 8. Instead, as described in detail herein, circuit interrupter system 2′, like circuit interrupter system 2, includes a settings emulator in the form of portable computing device 10 described in detail elsewhere herein that, in the illustrated embodiment, is structured to communicate with the microprocessor of electronic trip unit 8′ though a plug and play USB interface comprising USB cable 12 that is selectively connectable to a USB module 78 described in detail herein that is selectively connectable to electronic trip unit 8′. In this configuration, computing device 10 acts as a USB host and electronic trip unit 8′ is recognized as a USB peripheral device (in particular, a human interface device (HID). Thus, an operator is able to the functionality of the GUI of computing device 10 that is described in detail herein via the USB interface.

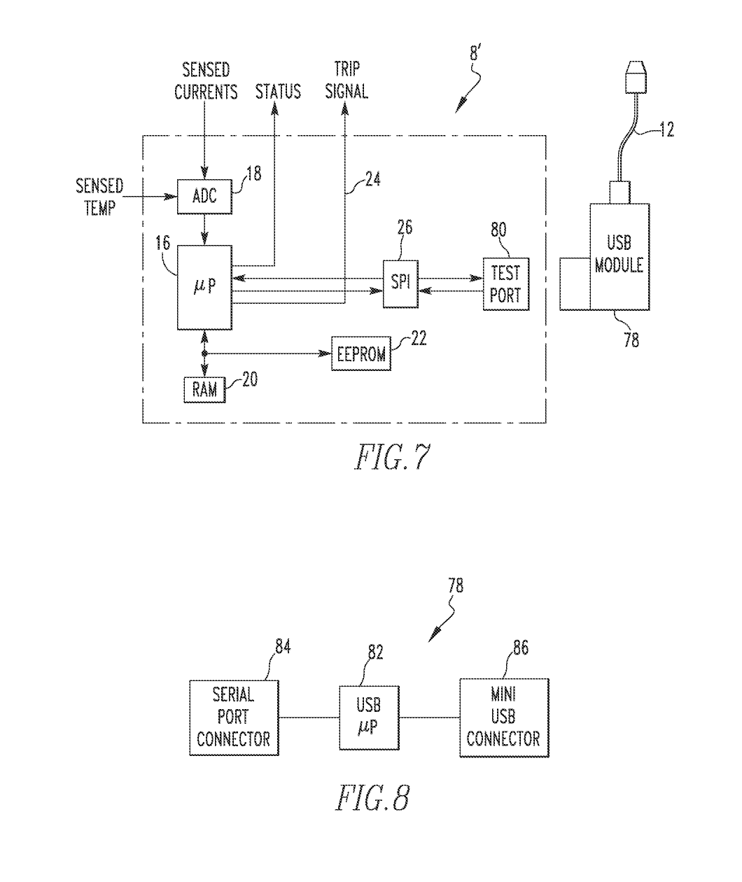

FIG. 7 is a schematic diagram showing USB module 78 and certain selected components of electronic trip unit 8′ according to the exemplary embodiment. As seen in FIG. 7, electronic trip unit 8′ includes many of the same components as electronic trip unit 8 described in detail herein, and like components are labeled with like reference numerals. However, as seen in FIG. 7, electronic trip unit 8′ does not include internal USB microprocessor 28 and mini USB connector 14. Instead, electronic trip unit 8′ includes a serial test port 80 (providing an external serial connection port for electronic trip unit 8′) that is connected to serial port interface (SPI) 26 provided as part of the PCB electronics of electronic trip unit 8′. SPI 26 is operatively coupled to microprocessor 16 to allow for serial communication with microprocessor 16. As seen in FIG. 7, USB module 78 is structured to be selectively connectable to SPI 26 to allow electronic trip unit 8′ to connect with the USB host of computing device 10 and plug and play communicate with that USB host as described elsewhere herein.

In particular, FIG. 8 is a block diagram of USB module 78 according to an exemplary embodiment. USB module 78 includes a USB microprocessor 82, which is similar to USB microprocessor 28 and which, as described elsewhere herein, is an integrated circuit chip that is configured to run a USB stack, a serial port connector 84 structured to be able to be connected to test port 80, and a mini USB connector 86. When computing device 10 is coupled to electronic trip unit 8′ through USB module 78, USB microprocessor 82 (running the USB stack) of USB module 78 allows electronic trip unit 8′ to connect with the USB host of computing device 10 and plug and play communicate with that USB host (using the on-board serial port interface (SPI) that enables communication with SPI 26 and thus provides for communication between USB microprocessor 82 and microprocessor 16).

Thus, circuit interrupter system 2′ utilizing USB module 78 is able to provide all of the functionality described herein in connection with circuit interrupter system 2 for a circuit interrupter 4′ having a standard test port 80.

In another embodiment, GUI 42 may be used implement diagnostic/wellness functionality when computing device 10 is coupled to electronic trip unit 8 or electronic trip unit 8′ using the USB connection. In particular, GUI 42 may be configured to monitor the “health” of either the system to which circuit interrupter 4 or circuit interrupter 4′ is connected or a component of the circuit interrupter 4 or circuit interrupter 4′ itself. For example, in a wind turbine, if the main gear wears, an abnormal pattern will be present in the current of the wind turbine. Thus, if circuit interrupter 4 or circuit interrupter 4′ is connected to such a wind turbine, GUI 42 may measure and monitor the current of the wind turbine (the relevant data is communicated from the microprocessor of the electronic trip unit to microprocessor 38 of computing device 10 through the USB interconnection between the two devices) and then compare that monitored current to a normal, expected current pattern. When abnormalities in the monitored current pattern are detected (as compared to a normal, expected pattern), wear of the main gear may be indicated. As will be appreciated, this concept (diagnostics based on current patterns) is not limited to just wind turbines, but may be applied in other areas as well wherein abnormal current patterns may indicate an adverse or deteriorated health state of a component. As other examples, GUI 42 may be configured to monitor current transformer (CT) insulation breakdown and/or contact wear/breakdown (based on measured resistances) within circuit interrupter 4 or circuit interrupter 4′, with such conditions being displayed on GUI 42. It will be appreciated that the above embodiments are merely exemplary and that still other diagnostic/wellness functionalities may be implemented within GUI 42.

In each of the embodiments described herein, the trip unit microprocessor (μP) 16 has a serial interface to a separate USB processor. In an alternative embodiment, trip unit microprocessor (μP) 16 may have USB functionality built therein, so as to eliminate the need for the serial interface to a separate USB processor. While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A circuit interrupter system, comprising:
a circuit interrupter including a processing unit, the circuit interrupter being configured to run a USB stack; and
a portable computing device selectively connectable to the circuit interrupter through a USB connection, the portable computing device being structured to function as a USB host and to implement a graphical user interface for enabling communication between the portable computing device and the processing unit of the circuit interrupter when the portable computing device is connected to the circuit interrupter through a USB connection.

2. The circuit interrupter system according to claim 1, the circuit interrupter including a serial port interface operatively coupled to the processing unit for enabling communication with the processing unit, and a USB processing unit configured to run the USB stack and operatively coupled to the serial port interface for enabling communication with the processing unit through the serial port interface, the portable computing device being selectively connectable to the USB processing unit of the circuit interrupter through the USB connection, the portable computing device being structured to function as the USB host and to implement the graphical user interface for enabling communication between the portable computing device and the processing unit of the circuit interrupter through the serial port interface and the USB processing unit when the portable computing device is connected to the USB processing unit of the circuit interrupter.

3. The circuit interrupter system according to claim 2, wherein the circuit interrupter includes an electronic trip unit having printed circuit board electronics, and wherein the processing unit, the USB processing unit, and the serial port interface are part of the printed circuit board electronics.

4. The circuit interrupter system according to claim 2, wherein the circuit interrupter includes an electronic trip unit having printed circuit board electronics, wherein the processing unit and the serial port interface are part of the printed circuit board electronics, and wherein the USB processing unit is provided on a USB module selectively connectable to a port of the electronic trip unit that is coupled to the serial port interface.

5. The circuit interrupter system according to claim 1, wherein the circuit interrupter includes an electronic trip unit, and wherein the graphical user interface is configured to enable one or more functional trip settings of the electronic trip unit to be adjusted and/or determined and displayed using the portable computing device when the portable computing device is connected to the circuit interrupter.

6. The circuit interrupter system according to claim 1, wherein the circuit interrupter includes an electronic trip unit, and wherein the graphical user interface is configured to allow a Zone Selective Interlocking option of the electronic trip unit to be enabled and disabled using the portable computing device when the portable computing device is connected to the circuit interrupter.

7. The circuit interrupter system according to claim 1, wherein the circuit interrupter includes an electronic trip unit, and wherein the graphical user interface is configured to allow a Remote Maintenance Mode of the electronic trip unit to be enabled and disabled using the portable computing device when the portable computing device is connected to the circuit interrupter.

8. The circuit interrupter system according to claim 1, wherein the circuit interrupter includes an electronic trip unit, and wherein the graphical user interface is configured to allow an over temperature set point of the electronic trip unit to be changed using the portable computing device when the portable computing device is connected to the circuit interrupter.

9. The circuit interrupter system according to claim 1, wherein the graphical user interface is configured to obtain and display a cause of trip of the circuit interrupter using the portable computing device when the portable computing device is connected to the circuit interrupter.

10. The circuit interrupter system according to claim 1, wherein the circuit interrupter includes an electronic trip unit, wherein the graphical user interface is configured to enable one or more first functional trip settings of the electronic trip unit to be adjusted and one or more additional functional trip settings of one or more additional circuit interrupters to be adjusted using the portable computing device when the portable computing device is connected to the circuit interrupter and to one or more additional circuit interrupters, thereby enabling the portable computing device to perform selective coordination among the circuit interrupter and the one or more additional circuit interrupters.

11. A circuit interrupter, comprising:
a processing unit;
a serial port interface operatively coupled to the processing unit for enabling communication with the processing unit; and
a USB processing unit configured to run a USB stack and operatively coupled to the serial port interface for enabling communication with the processing unit through the serial port interface, wherein the circuit interrupter is configured to function as a USB peripheral responsive to a portable computing device functioning as a USB host being connected to the USB processing unit through a USB connection to thereby enable communication between the portable computing device and the processing unit of the circuit interrupter through the serial port interface and the USB processing unit.

12. The circuit interrupter according to claim 11, wherein the circuit interrupter includes an electronic trip unit having printed circuit board electronics, and wherein the processing unit, the USB processing unit, and the serial port interface are part of the printed circuit board electronics.

13. The circuit interrupter according to claim 11, wherein the circuit interrupter includes an electronic trip unit having printed circuit board electronics, wherein the processing unit and the serial port interface are part of the printed circuit board electronics, and wherein the USB processing unit is provided on a USB module selectively connectable to a port of the electronic trip unit that is coupled to the serial port interface.

14. A portable computing device structured to be selectively connectable to a circuit interrupter through a USB connection, comprising:
a display; and
a processor apparatus storing one or more routines executable by the processor apparatus, the one or more routines being adapted to:
cause the portable computing device to function as a USB host; and
implement a graphical user interface displayable on the display, the graphical user interface enabling communication between the portable computing device and a processing unit of the circuit interrupter when the portable computing device is connected to the circuit interrupter.

15. The portable computing device according to claim 14, the portable computing device structured to be selectively connectable to a USB processing unit of the circuit interrupter through the USB connection, the graphical user interface enabling communication between the portable computing device and the processing unit of the circuit interrupter through a serial port interface coupled to the processing unit of the circuit interrupter and the USB processing unit when the portable computing device is connected to the USB processing unit of the circuit interrupter.

16. The portable computing device according to claim 14, wherein the circuit interrupter includes an electronic trip unit, and wherein the graphical user interface is configured to enable one or more functional trip settings of the electronic trip unit to be adjusted and/or determined and displayed on the display using the portable computing device when the portable computing device is connected to the circuit interrupter.

17. The portable computing device according to claim 14, wherein the circuit interrupter includes an electronic trip unit, and wherein the graphical user interface is configured to allow a Zone Selective Interlocking option of the electronic trip unit to be enabled and disabled using the portable computing device when the portable computing device is connected to the circuit interrupter.

18. The portable computing device according to claim 14, wherein the circuit interrupter includes an electronic trip unit, and wherein the graphical user interface is configured to allow a Remote Maintenance Mode of the electronic trip unit to be enabled and disabled using the portable computing device when the portable computing device is connected to the circuit interrupter.

19. The portable computing device according to claim 14, wherein the circuit interrupter includes an electronic trip unit, and wherein the graphical user interface is configured to allow an over temperature set point of the electronic trip unit to be changed using the portable computing device when the portable computing device is connected to the circuit interrupter.

20. The portable computing device according to claim 14, wherein the graphical user interface is configured to obtain and display on the display a cause of trip of the circuit interrupter when the portable computing device is connected to the circuit interrupter.

21. The portable computing device according to claim 14, wherein the circuit interrupter includes an electronic trip unit, wherein the graphical user interface is configured to enable one or more first functional trip settings of the electronic trip unit to be adjusted and one or more additional functional trip settings of one or more additional circuit interrupters to be adjusted using the portable computing device when the portable computing device is connected to the circuit interrupter and to one or more additional circuit interrupters, thereby enabling the portable computing device to perform selective coordination among the circuit interrupter and the one or more additional circuit interrupters.

22. A computer program product tangibly embodied on a computer readable medium of a portable computing device structured to be selectively connectable to a circuit interrupter through a USB connection, the computer program product comprising one or more routines executable by a processor apparatus of the portable computing device, the one or more routines being adapted to:
implement a graphical user interface displayable on a display of the portable computing device, the graphical user interface enabling communication between the portable computing device and a processing unit of the circuit interrupter when the portable computing device is connected to the circuit interrupter.

23. The computer program product according to claim 22, wherein the circuit interrupter includes an electronic trip unit, and wherein the graphical user interface is configured to enable one or more functional trip settings of the electronic trip unit to be adjusted and/or determined and displayed on the display using the portable computing device when the portable computing device is connected to the circuit interrupter.

24. The computer program product according to claim 22, wherein the circuit interrupter includes an electronic trip unit, and wherein the graphical user interface is configured to allow a Zone Selective Interlocking option of the electronic trip unit to be enabled and disabled using the portable computing device when the portable computing device is connected to the circuit interrupter.

25. The computer program product according to claim 22, wherein the circuit interrupter includes an electronic trip unit, and wherein the graphical user interface is configured to allow a Remote Maintenance Mode of the electronic trip unit to be enabled and disabled using the portable computing device when the portable computing device is connected to the circuit interrupter.

26. The computer program product according to claim 22, wherein the circuit interrupter includes an electronic trip unit, and wherein the graphical user interface is configured to allow an over temperature set point of the electronic trip unit to be changed using the portable computing device when the portable computing device is connected to the circuit interrupter.

27. The computer program product according to claim 22, wherein the graphical user interface is configured to obtain and display on the display a cause of trip of the circuit interrupter when the portable computing device is connected to the circuit interrupter.

28. The computer program product according to claim 22, wherein the circuit interrupter includes an electronic trip unit, wherein the graphical user interface is configured to enable one or more first functional trip settings of the electronic trip unit to be adjusted and one or more additional functional trip settings of one or more additional circuit interrupters to be adjusted using the portable computing device when the portable computing device is connected to the circuit interrupter and to one or more additional circuit interrupters, thereby enabling the portable computing device to perform selective coordination among the circuit interrupter and the one or more additional circuit interrupters.

29. The computer program product according to claim 22, wherein the one or more routines are further adapted to cause the portable computing device to function as a USB host.

30. The computer program product according to claim 22, wherein the graphical user interface is configured to monitor a wear state of a system to which the circuit interrupter is connected or a component of the circuit interrupter.

31. The computer program product according to claim 22, wherein the graphical user interface is configured to monitor the wear state based on a monitored current pattern generated from current data received from the circuit interrupter and a normal, expected current pattern.
